(19) United States
(12) Patent Application Publication
(10) Pub. No.: US 2005/0035097 A1
(43) Pub. Date: Feb. 17, 2005

(54) Altering the emission of an ablation beam for safety or control

(76) Inventor: Richard Stoltz, Plano, TX (US)

Correspondence Address: CHALKER FLORES, LLP, 12700 PARK CENTRAL, STE. 455, DALLAS, TX, 75251, US

(21) Appl. No.: 10/849,586

(22) Filed: May 19, 2004

Related U.S. Application Data
(60) Provisional application No. 60/494,267, filed on Aug. 11, 2003.
(60) Provisional application No. 60/503,578, filed on Sep. 17, 2003.

(51) Int. Cl. B23K 26/36

(52) U.S. Cl. 219/121.69; 219/121.83

(57) ABSTRACT

The present invention includes an apparatus and a method of controlling the emission of a surgical ablation beam in a beam path from a surgical-probe end, including setting a maximum distance for ablation into a beam control system, measuring the distance from the surgical-probe end to a object in the beam path, and blocking the ablation beam based on the distance between the end of the ablation probe and an object for safety or ablation control reasons.

### CROSS-REFERENCE TO RELATED APPLICATIONS

This application claims priority to U.S. Provisional Patent Applications, Ser. No. 60/494,267, entitled “Altering The Emission Of An Ablation Beam for Safety or Control,” filed Aug. 11, 2003 (Docket No. ABI-15); and Ser. No. 60/503,578, entitled “Controlling Optically-Pumped Optical Pulse Amplifiers,” filed Sep. 17, 2003 (Docket No. ABI-23).

### TECHNICAL FIELD OF THE INVENTION

The present invention relates in general to the field of light amplification and, more particularly to the altering the emission of an ablation beam for safety or control.

### BACKGROUND OF THE INVENTION

Ablative material removal is especially useful for medical purposes, either in-vivo or on the outside surface (e.g., skin or tooth), as it is essentially non-thermal and generally painless. Ablative removal of material is generally done with a short optical pulse that is stretched amplified and then compressed. A number of types of laser amplifiers have been used for the amplification.

Laser machining can remove ablatively material by disassociate the surface atoms and melting the material. Laser ablation is done efficiently with a beam of short pulses (generally a pulse-duration of three picoseconds or less). Techniques for generating these ultra-short pulses (USP) are described, e.g., in a book entitled “Femtosecond Laser Pulses” (C. Rulliere, editor), published 1998, Springer-Verlag Berlin Heidelberg New York. Generally large systems, such as Ti:Sapphire, are used for generating ultra-short pulses (USP).

USP phenomenon was first observed in the 1970's, when it was discovered that mode-locking a broad-spectrum laser could produce ultra-short pulses. The minimum pulse duration attainable is limited by the bandwidth of the gain medium, which is inversely proportional to this minimal or Fourier-transform-limited pulse duration. Mode-locked pulses are typically very short and will spread (i.e., undergo temporal dispersion) as they traverse any medium. Subsequent pulse-compression techniques are often used to obtain USP's. Pulse dispersion can occur within the laser cavity so that compression techniques are sometimes added intra-cavity. When high-power pulses are desired, they are intentionally lengthened before amplification to avoid internal component optical damage. This is referred to as “Chirped Pulse Amplification” (CPA). The pulse is subsequently compressed to obtain a high peak power (pulse-energy amplification and pulse-duration compression).

### SUMMARY OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Ablative material removal with a short optical pulse is especially useful for medical purposes and can be preformed either in-vivo or on the body surface, as it is essentially non-thermal and generally painless. This present invention provides for blocking or otherwise altering the emission of an ablation beam based on the distance between the end of the ablation probe and the nearest object for safety or ablation control reasons. The present invention allows ablation pulses only within predefined distance from target (or within a predefined range) based on measurements, such as sonic feedback, or size of conical or cross-shaped auxiliary light beam with on target, or from backpressure of an air-jet (or air-jet and suction combination). One Embodiment of the present invention can have audible and/or visible (e.g., color change of the auxiliary beam) as an indication of when ablation pulse is active. One Embodiment of the present invention can also vary the length of a scanned ablation beam and the length of the auxiliary light-beam as a function of the distance from the target, e.g., to give the effect of a pointed scalpel blade.

Some embodiments have a user controlled beam-enabling switch, and in some embodiments there is an audible signal when the beam is on. In some embodiments, a minimum distance for ablation is set into the beam control system, and the beam is blocked if no signal indicating a distance between the minimum and the maximum distance is received. Thus, this system not only helps to avoid accidental injuries or damage, but also makes using the probe more convenient.

One embodiment of the present invention is a method of controlling a surgical ablation beam emitted in a beam path from a surgical-probe end, including setting a maximum distance for ablation into a beam control system; measuring the distance from the surgical-probe end to a nearest object in the beam path; blocking the ablation beam when the measured distance is greater than the set maximum distance for ablation.

In some embodiments, the beam is amplified by a fiber amplifier and the blocking is by shutting off the current to the fiber-amplifiers pump diodes. In other embodiments, the beam is amplified in a semiconductor optical amplifier and the blocking is by shutting off the current to the semiconductor optical amplifier.

In one embodiment, the measurement is measured sonically. In another embodiment, the measurement is by measuring backpressure from an air-jet (or air-jet and suction combination) with a high pressure on the air-jet or low absolute pressure on the suction indicating the probe is below the minimum distance from an object. The beam is blocked if no signal indicating a distance less than the maximum distance is received. In still another embodiment, the measurement is by measuring a dimension of size of an auxiliary light beam on an object and blocking the beam if no signal indicating a distance less than the maximum distance is received. The auxiliary light beam is also used to indicate to a user where the ablation will take place. In some embodiments, the auxiliary light beam may be conical or have a cross shape. In other embodiments, the auxiliary light beam may change color when the ablation beam is on. In one embodiment the ablation beam is scanned. The beam scan length and auxiliary light-beam length are both variable as a function of the distance from the object, whereby the beam is controlled to give the effect of a pointed scalpel blade.

In some embodiments, the beam is blocked when the probe is too close to an object. The distance can be measured by any of a number of techniques known in the art. For example, the measurement can by achieved by measuring backpressure from an air-jet (or an air-jet and suction combination), with a high pressure on the airjet or low absolute pressure on the suction indicating the probe is below the minimum distance from an object.

### DETAILED DESCRIPTION OF THE INVENTION

Ablative material removal with a short optical pulse is especially useful for medical purposes and can be preformed either in-vivo or on the body surface. In one embodiment, a fiber-amplifier powers the optical pulses. In other embodiments a semiconductor-optical-amplifier powers the optical pulses. One Embodiment of the invention provides for blocking or otherwise altering the emission of an ablation beam based on the distance between the end of the ablation probe and the nearest object for safety or ablation control reasons.

One Embodiment of the invention allows ablation pulses only within predefined distance from target (or within a predefined range) based on measurements, such as sonic feedback (measuring time between “ping” and receiving of the echo), or size of conical or cross-shaped auxiliary light beam with on target, or from backpressure of an air-jet (or air-jet and suction combination) as a nearby object slows the flow and raises the jet backpressure (or drops the absolute pressure in the suction line). The beam is blocked when a signal indicating a distance greater than the maximum distance is received.

One Embodiment of the invention also varies the length of a scanned ablation beam and the length of the auxiliary light-beam as a function of the distance from the target, e.g., to give the effect of a pointed scalpel blade. In some embodiments, there is a user controlled beam-enabling switch. In some embodiments, a minimum distance for ablation is set into the beam control system, and the beam is blocked if no signal indicating a distance between the minimum and the maximum distance is received. Thus, this system not only helps to avoid accidental injuries or damage, but also makes using the probe more convenient. Some embodiments have an audible signal when the beam is on. Other embodiments may have an audible and/or visible (e.g., color change of the auxiliary beam) indication of ablation pulse is activation.

One embodiment of the present invention is a method of controlling a ablation beam emitted in a beam path from a surgical-probe end, including setting a maximum distance for ablation into a beam control system; measuring the distance from the surgical-probe end to an object in the beam path; blocking the ablation beam when the measured distance is greater than the set maximum distance for ablation.

In one embodiment, the beam is amplified by an optically pumped amplifier and blocking the ablation beam is accomplished by shutting off the current to the amplifiers pump diodes. In another embodiment, the beam is amplified by a fiber amplifier. In yet another embodiment, the beam is amplified in a semiconductor optical amplifier and blocking the ablation beam is accomplished by shutting off the current to the semiconductor optical amplifier. In another embodiment of the present invention, the beam is blocked by blocking the amplifier input signal by shutting off the current to a semiconductor optical preamplifier. In other embodiments of the present invention, the beam is blocked by insertion of an adsorbing material in the beam path. Those skilled in the art will recognize that other methods of blocking the beam. Further, the beam can be blocked through a combination of the preceding (and other) methods.

One embodiment of the present invention controls pump diode current to control the fiber-amplifier to a predetermined temperature. One embodiment of the present invention can adjust the repetition rate of the pulse generator to control the pulse energy for efficient material removal. One embodiment creates a series of wavelength-swept-with-time pulses at a fixed repetition rate, and a fraction those fixed repetition rate pulses are selected. The selected fraction of pulses is varied controllably to give a selected pulse repetition rate. One embodiment of the present invention uses more than one amplifier in a train mode (pulses from one amplifier being delayed to arrive one or more nanoseconds after those from another amplifier) allowing the step-wise control of ablation rate independent of pulse energy.

Another embodiment of the present invention uses a video camera and the video signal is monitored to determine the distance (e.g., monitoring the longest time in which the colored auxiliary beam remains in a video scan). The spot size can be measured using a stationary spot or using a linear scan. Other embodiments allow the distance measurement to be determined using an infrared beam, an infrared camera and the infrared video signal monitored (e.g., monitoring the longest time in which the infrared auxiliary beam remains in a video scan).

In one embodiment, the distance is determined by measuring a dimension of size of an auxiliary light beam displayed on the nearest object and the beam is blocked if no signal indicating a distance less than the maximum distance is received.

In some embodiments the auxiliary light beam may also used to indicate, to a surgeon, where the ablation will take place. In others embodiments, the auxiliary light beam may be conical or have a cross shape. In some embodiments, the auxiliary light beam interacts with the ablation beam to produce a color when the ablation beam is on. In one embodiment, the beam is scanned. The beam scan length and auxiliary light-beam length may both be varied as a function of the distance from the object, whereby the beam is controlled to give the effect of a pointed scalpel blade.

In one embodiment, the ablation probe can be mounted on an x-y-z-positioner, and the probe moved in the z-direction to follow surfaces that are not flat. In some embodiments, a smaller ablation areas may be scanned by moving the beam without moving the probe. Large areas may be scanned by moving the beam over a first area, and then stepping the probe to second portion of the large area and then scanning the beam over the second area, and so on. In some embodiments, the scanning of the beam is through beam deflecting mirrors mounted on piezoelectric actuators (see “Scanned Small Spot Ablation With A High-Rep-Rate” U.S. Provisional Patent Applications, Ser. No. 60/471,972, Docket No. ABI-6; filed May 20, 2003; which is incorporated by reference herein). In one embodiment, the beam scanner positions the beam only over a defined color. In other embodiments, the system actuators scan over a larger region but with the ablation beam only enabled to ablate portions with the defined color and/or area.

Typically, medical ablation has a threshold of less than one (1) Joule per square centimeter, but occasionally surgical removal of foreign material may require dealing with an ablation threshold of up to about two (2) Joules per square centimeter. In one embodiment, the ablation rate is controllable independent of pulse energy. In one embodiment, the invention has two or more amplifier arranged in train mode (pulses from one amplifier being delayed to arrive one or more nanoseconds after those from another amplifier) allowing step-wise control of ablation rate independent of pulse energy. For example, 20 amplifiers would yield a maximum of 20 pulses in a train. Other embodiments of the present invention may uses only three or four amplifiers and three or four pulses per train. Other embodiments having two or more amplifier arranged in train mode and requiring a lower ablation rate allow one or more amplifiers can be shut off (e.g., the optical pumping to the fiber amplifier shut off), resulting in fewer pulses per train.

Generally, optically-pumped amplifiers are optically-pumped continuous wave (CW) or quasi-CW (pumping and amplifying perhaps 500 times per second in one (1) millisecond bursts). In quasi-CW, there is a pause between bursts, and the ratio of durations of the pause and the burst may be adjusted for component temperature and/or average repetition rate control. While CW operation might generally be used in operating amplifiers, amplifiers might be run in a staggered fashion, e.g., on for a first period and then turned off for one second period, and a first period dormant amplifier turned on during the second period, and so forth, to spread the heat load.

One embodiment of the present invention combines an optically-pumped-amplifier and a small pulse-compressor, enabling the invention to be man-portable. As used herein, the term “man-portable” generally means capable of being moved reasonably easily by one person. In one embodiment the man-portable system is a wheeled cart. In another embodiment the man-portable system is a backpack.

One embodiment includes a sub-picosecond pulses of between ten (10) picoseconds and one nanosecond, selection of the pulse, a fiber-amplifier (e.g., a erbium-doped fiber amplifier or EDFA) amplifying the selected pulses and pulse compression by an air-path between gratings compressor (e.g., a Tracey grating compressor), with the compression creating a sub-picosecond ablation pulse. In one embodiment, a semiconductor oscillator is used to generate pulses. In some embodiments, a semiconductor optical amplifier (SOA) preamplifier is used to amplify the selected pulses before introduction into the optically-pumped amplifier.

One embodiment of the present invention includes a compressor having inputs from more than one amplifier. Reflections from other the parallel amplifiers may result in a loss of efficiency, and thus should be minimized. The loss is especially important if the amplifiers are amplifying signals at the same time, as is the case with the SOAs. In one embodiment each off the parallel SOAs has a compressor and the amplified pulses are placed into a single fiber after the compressors, thereby, reducing greatly reflections from the joining (e.g., in a star connector).

Fiber amplifiers have a storage lifetime of about 100 to 300 microseconds. While some measurements have been made at higher repetition rates, (and these measurements have shown an approximately linear decrease in pulse energy), and for ablations purposes, fiber amplifiers have been operated with a time between pulses of equal to or greater than the storage lifetime, and thus are generally run a repetition rate of less than 3-10 kHz. One embodiment of the present invention has fiber amplifiers using a single compressor, as the nanosecond spacing of sub-nanosecond pulses minimizes amplifying of multiple signals at the same time.

Optically-pumped amplifiers are available with average power of 30 W or more. A moderate-power 5 W average power optically-pumped amplifier has been operated to give pulses of 500 microJoules or more, as energy densities above the ablation threshold are needed for non-thermal ablation, and increasing the energy in such a system, increases the ablation rate in either depth or allows larger areas of ablation or both. One embodiment of the present invention includes a optically-pumped amplifier with a time between pulses of a fraction (e.g., one-half or less) of the storage lifetime and use a smaller ablation spot. In one embodiment the ablation spot is less than about 50 microns in diameter.

One embodiment of the present invention includes parallel optically-pumped amplifiers to generate a train of pulses to increase the effective repetition rate and, thus, increase the ablation rate. The train pulse allows control of ablation rate by the use of a lesser number of operating optically-pumped amplifiers and, thus, avoid thermal problems. Other embodiments have a SOA preamplifier to amplify the initial pulse before splitting to drive multiple parallel optically-pumped amplifiers and another SOA before the introduction of the signal into each optically-pumped amplifier, whereby individual optically-pumped amplifiers can be rapid shutting down. In one embodiment the pulse generator controls the input repetition rate of the optically-pumped amplifiers to tune energy per pulse to about three times threshold per pulse.

One embodiment of the present invention uses a 1 ns pulse with a optically-pumped amplifier and air optical-compressor (e.g., a Tracey grating compressor) typically gives compression with approximately 40% losses. At less than 1 ns, the losses in a Tracey grating compressor are generally lower. If the other-than-compression losses are 10%, 2 nanoJoules are needed from the amplifier to get 1 nanoJoule on the target. The use of greater than 1 ns pulses in an air optical-compressor presents two problems; the difference in path length for the extremes of long and short wavelengths needs to be more 3 cm and thus the compressor is large and expensive, and the losses increase with a greater degree of compression.

One embodiment of the present invention generates an initial pulse using a semiconductor. The semiconductor pulse generator produces an initial wavelength-swept-with-time initial pulse that is a sub-picosecond pulse and is time-stretching. A SOA preamplifier is then used to amplify the initial pulse before splitting to drive multiple amplifiers, producing an ablation spot. The ablation spot is then scanned to get a larger effective ablation area. In some embodiments the SOA scanned spot is smaller than in optically-pumped-amplifier case.

One embodiment of the present invention uses parallel amplifiers to generate a train of pulses allowing control of input optical signal power, optical pumping power of optically-pumped amplifiers, timing of input pulses, length of input pulses, and timing between start of optical pumping and start of optical signals to control pulse power, and average degree of energy storage in optically-pumped.

In one embodiment, operating less than all of the multiple amplifiers, the temperature can be regulated through switching optically-pumped amplifiers. For example, one might rotate the running of ten optically-pumped amplifiers such that only five were operating at any one time (e.g., each on for 1/10^{th} of a second and off for 1/10^{th} of a second). Another embodiment uses ten optically-pumped amplifiers with time spaced inputs, e.g., by 1 ns, to give a train of one to 10 pulses. With 5 W amplifiers operating at 100 kHz (and e.g., 50 microJoules) this could step between 100 kHz and 1 MHz. With 50% post-amplifier optical efficiency and 50 microJoules, to get 6 Joules/square centimeter on the target, the spot size would be about 20 microns. Another embodiment of the present invention uses 20 optically-pumped amplifiers with time spaced inputs, e.g., by 1 ns, to give a train of one to 20 pulses. With 5 W amplifiers operating at 50 kHz (and e.g., 100 microJoules) this could step between 50 kHz and 1 MHz. With 50% post-amplifier optical efficiency and 100 microJoules, to get 6 Joules/square centimeter on the target, the spot size would be about 33 microns. The amplified pulse might be 50 to 100 picoseconds long. A similar embodiment with 10 optically-pumped amplifiers could step between 50 kHz and 500 kHz. Another embodiment uses 5 W amplifiers operating at 20 kHz (and e.g., 250 microJoules) and with 10 Cr:YAG optically-pumped amplifiers this could step between 20 kHz and 200 kHz. With 50% post-amplifier optical efficiency and 250 microJoules, to get 6 Joules/square centimeter on the target, the spot size would be about 50 microns. The amplified pulse might be 100 to 250 picoseconds long. A similar embodiment with 30 optically-pumped amplifiers could step between 20 kHz and 600 kHz.

Generally, the use of a shorter amplified pulse, allows the use of a smaller the compressor. However, some types of optically-pumped amplifiers have a maximum pulse power of 4 MW, and thus a 10-microJoule amplified pulse could generally be no shorter than 2 ps. One embodiment of the present invention uses a 10 ps, 10 microJoule pulse, at 500 kHz (or 50 microJoule with 100 kHz).

One embodiment of the present invention measures the light leakage during delivery to produce a feedback proportional to pulse power and/or energy for control purposes. One embodiment of the present invention uses 1550 nm light.

One embodiment includes a camera, using an optical fiber in a probe to convey an image to a camera, e.g., a vidicon-containing remote camera body. One embodiment has a camera using a handheld beam-emitting probe and can supply its own illumination. Other embodiments use cameras having an optical fiber in a probe to convey an image back to a remote camera body, e.g., a vidicon-containing camera with a GRIN fiber lens. Other embodiments of the present invention may use an endoscope type camera. Another embodiment of the present invention uses a camera “in-vivo” (see “Camera Containing Medical Tool” U.S. Provisional Patent Applications, Ser. No. 60/472,071; Docket No. ABI-4; filed May 20, 2003; which is incorporated by reference herein).

One embodiment scans a smaller ablation area by moving the beam without moving the probe. Large areas may be scanned by moving the beam over a first area, and then stepping the probe to second portion of the large area and then scanning the beam over the second area, and so on. The scanning may be by beam deflecting mirrors mounted on piezoelectric actuators (see “Scanned Small Spot Ablation With A High-Rep-Rate” U.S. Provisional Patent Applications, Ser. No. 60/471,972, Docket No. ABI-6; filed May 20, 2003; which is incorporated by reference herein). In one embodiment, the system actuators scan over a larger region but with the ablation beam only enabled to ablate portions with defined color and/or area. In other embodiments a combination of time and, area and/or color, can be preset, e.g., to allow evaluation after a prescribed time.

Information of such a system and other information on ablation systems are given in co-pending provisional applications listed in the following paragraphs (which are also at least partially co-owned by, or exclusively licensed to, the owners hereof) and are hereby incorporated by reference herein (provisional applications listed by docket number., title and United States Provisional Patent Applications, Serial number):

Docket Number ABI-1 “Laser Machining” U.S. Provisional Patent Applications, Ser. No. 60/471,922; Docket No. ABI-4 “Camera Containing Medical Tool” U.S. Provisional Patent Applications, Ser. No. 60/472,071; Docket No. ABI-6 “Scanned Small Spot Ablation With A High-Rep-Rate” U.S. Provisional Patent Applications, Ser. No. 60/471,972; and Docket No. ABI-7 “Stretched Optical Pulse Amplification and Compression”, U.S. Provisional Patent Applications, Ser. No. 60/471,971, were filed May 20, 2003;

Docket No. ABI-8 “Controlling Repetition Rate Of Fiber Amplifier” U.S. Provisional Patent Applications, Ser. No. 60/494,102; Docket No. ABI-9 “Controlling Pulse Energy Of A Fiber Amplifier By Controlling Pump Diode Current” U.S. Provisional Patent Applications, Ser. No. 60/494,275; Docket No. ABI-10 “Pulse Energy Adjustment For Changes In Ablation Spot Size” U.S. Provisional Patent Applications, Ser. No. 60/494,274; Docket No. ABI-11 “Ablative Material Removal With A Preset Removal Rate or Volume or Depth” U.S. Provisional Patent Applications, Ser. No. 60/494,273; Docket No. ABI-12 “Fiber Amplifier With A Time Between Pulses Of A Fraction Of The Storage Lifetime”; Docket No. ABI-13 “Man-Portable Optical Ablation System” U.S. Provisional Patent Applications, Ser. No. 60/494,321; Docket No. ABI-14 “Controlling Temperature Of A Fiber Amplifier By Controlling Pump Diode Current” U.S. Provisional Patent Applications, Ser. No. 60/494,322; Docket No. ABI-16 “Enabling Or Blocking The Emission Of An Ablation Beam Based On Color Of Target Area” U.S. Provisional Patent Applications, Ser. No. 60/494,172; Docket no. ABI-17 “Remotely-Controlled Ablation of Surfaces” U.S. Provisional Patent Applications, Ser. No. 60/494,276 and Docket No. ABI-18 “Ablation Of A Custom Shaped Area” U.S. Provisional Patent Applications, Ser. No. 60/494,180; were filed Aug. 11, 2003. Docket No. ABI-19 “High-Power-Optical-Amplifier Using A Number Of Spaced, Thin Slabs” U.S. Provisional Patent Applications, Ser. No. 60/497,404 was filed Aug. 22, 2003;

Co-owned Docket No. ABI-20 “Spiral-Laser On-A-Disc”, U.S. Provisional Patent Applications, Ser. No. 60/502,879; and partially co-owned Docket No. ABI-21 “Laser Beam Propagation in Air”, U.S. Provisional Patent Applications, Ser. No. 60/502,886 were filed on Sep. 12, 2003. Docket No. ABI-22 “Active Optical Compressor” U.S. Provisional Patent Applications, Ser. No. 60/503,659 and Docket No. ABI-23 “Controlling Optically-Pumped Optical Pulse Amplifiers” U.S. Provisional Patent Applications, Ser. No. 60/503,578 were both filed Sep. 17, 2003;

Docket No. ABI-24 “High Power SuperMode Laser Amplifier” U.S. Provisional Patent Applications, Ser. No. 60/505,968 was filed Sep. 25, 2003, Docket No. ABI-25 “Semiconductor Manufacturing Using Optical Ablation” U.S. Provisional Patent Applications, Ser. No. 60/508,136 was filed Oct. 2, 2003, Docket No. ABI-26 “Composite Cutting With Optical Ablation Technique” U.S. Provisional Patent Applications, Ser. No. 60/510,855 was filed Oct. 14, 2003 and Docket No. ABI-27 “Material Composition Analysis Using Optical Ablation”, U.S. Provisional Patent Applications, Ser. No. 60/512,807 was filed Oct. 20, 2003;

Docket No. ABI-28 “Quasi-Continuous Current in Optical Pulse Amplifier Systems” U.S. Provisional Patent Applications, Ser. No. 60/529,425 and Docket No. ABI-29 “Optical Pulse Stretching and Compressing” U.S. Provisional Patent Applications, Ser. No. 60/529,443, were both filed Dec. 12, 2003;

ABI-30 “Start-up Timing for Optical Ablation System” U.S. Provisional Patent Applications, Ser. No. 60/539,026; Docket No. ABI-31 “High-Frequency Ring Oscillator”, U.S. Provisional Patent Applications, Ser. No. 60/539,024; and Docket No. ABI-32 “Amplifying of High Energy Laser Pulses”, U.S. Provisional Patent Applications, Ser. No. 60/539,025; were filed Jan. 23, 2004; and

Docket No. ABI-33 “Semiconductor-Type Processing for Solid-State Lasers”, U.S. Provisional Patent Applications, Ser. No. 60/543,086, was filed Feb. 9, 2004; and Docket No. ABI-34 “Pulse Streaming of Optically-Pumped Amplifiers”, U.S. Provisional Patent Applications, Ser. No. 60/546,065, was filed Feb. 18, 2004. Docket No. ABI-35 “Pumping of Optically-Pumped Amplifiers”, was filed Feb. 26, 2004.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification, but only by the claims.

1. A method of controlling the emission of an ablation beam in a beam path from a probe, comprising:
setting a maximum distance for ablation into a beam control system;
measuring the distance from the probe to an object in the beam path; and
blocking the ablation beam.

2. The method of claim 1, wherein the ablation beam is blocked when the measured distance is greater than the set maximum distance for ablation.

3. The method of claim 1, wherein the beam is amplified in a fiber amplifier and the blocking is by shutting off the current to the fiber-amplifiers pump diodes.

4. The method of claim 1, wherein the beam is amplified in a semiconductor optical amplifier and the blocking is by shutting off the current to the semiconductor optical amplifier.

5. The method of claim 1, wherein the distance is measured sonically.

6. The method of claim 1, wherein the distance is measured by measuring a dimension of size of an auxiliary light beam with on an object and blocking the beam if no signal indicating a distance less than the maximum distance is received, and the auxiliary light beam is also used to indicate where the ablation will take place.

7. The method of claim 6, wherein the auxiliary light beam is conical.

8. The method of claim 6, wherein the auxiliary light beam has a cross shape.

9. The method of claim 6, wherein the auxiliary light beam changes color when the beam is on.

10. The method of claim 1, further comprising enabling the beam by a switch.

11. The method of claim 1, wherein there is an audible signal when the beam is on.

12. The method of claim 6, further comprising scanning of the beam.

13. The method of claim 12, further comprising varying the beam scan length and auxiliary light-beam length as a function of the distance from the object, whereby the beam is controlled to give the effect of a pointed scalpel blade.

14. The method of claim 1, wherein the distance is measured is by measuring backpressure from air-jet or air-jet and suction combination and blocking the beam if no signal indicating a distance less than the maximum distance is received.

15. A method of controlling an ablation beam from emitting in a beam path from a probe end, comprising:
setting a maximum distance for ablation into a beam control system;
measuring the distance from the probe end to a nearest object in the beam path; and
blocking the ablation beam when the measured distance is greater than the set maximum distance for ablation.

16. The method of claim 15, wherein the beam is amplified in an optically-pumped amplifier and the blocking is by shutting off the current to the optically-pumped-amplifiers pump diodes.

17. The method of claim 15, wherein the distance is measured sonically.

18. The method of claim 15, wherein the distance is measured by measuring a dimension of size of conical auxiliary light beam with on the nearest object and blocking the beam if no signal indicating a distance less than the maximum distance is received.

19. The method of claim 15, wherein the distance is measured by measuring backpressure from air-jet or air-jet and suction combination and blocking the beam if no signal indicating a distance less than the maximum distance is received.

20. The method of claim 15, further comprising setting a minimum distance for ablation into the beam control system, and the beam is blocked if no signal indicating a distance between the minimum and the maximum distance is received.
